(19) United States
(12) Patent Application Publication
(10) Pub. No.: US 2014/0152113 A1
(43) Pub. Date: Jun. 5, 2014

(54) DISCHARGE CIRCUIT

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventor: CHUN-SHENG CHEN, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/071,608

(22) Filed: Nov. 4, 2013

(30) Foreign Application Priority Data
Nov. 30, 2012 (CN) 201210500873X

(51) Int. Cl. H02J 1/00

(52) U.S. Cl. CPC H02J 1/00
USPC 307/100

(57) ABSTRACT

A discharge circuit includes a power supply unit, a connector, and a jumper. The connector includes a number of pins defined in two rows with one of the pin is coupled to a power terminal provided by the power supply unit. The jumper is connected between the pin coupled to the power terminal and another pin connected to ground, to make the power terminal to discharge.

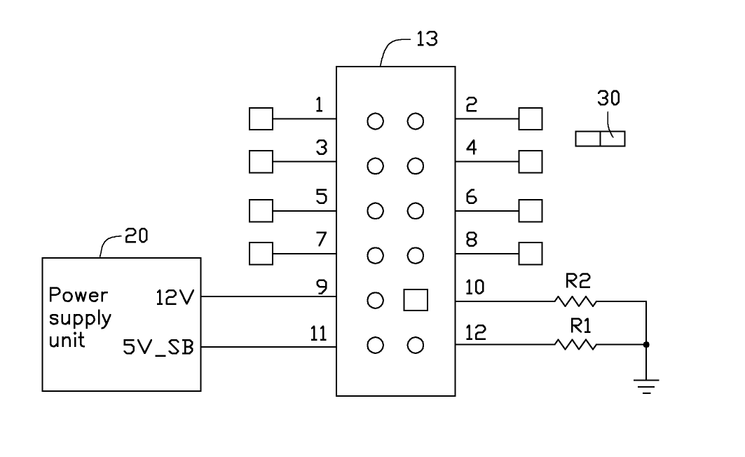

### BACKGROUND

1. Technical Field

The present disclosure relates to a discharge circuit.

2. Description of Related Art

A power supply unit includes various power terminals to provide power for components on a motherboard, and the power terminals may discharge automatically when the power supply unit is turned off an external power source. However, the automatically discharge times of the power terminals are different from one another. For example, a power terminal 5V_SB may take the most time to discharge in natural state. Accordingly, if a component has a different discharge time from that of its connected power terminal, the motherboard may be damaged.

Therefore, there is room for improvement in the art.

### BRIEF DESCRIPTION OF THE DRAWING

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

The FIGURE is a circuit diagram of an embodiment of a discharge circuit of the present disclosure.

### DETAILED DESCRIPTION

The FIGURE illustrates an embodiment of a discharge circuit for a power supply unit 20. The discharge circuit includes a connector 13, a jumper 30, and resistors R1 and R2.

The power supply unit 20 provides various power terminals, such as 12V and 5V_SB, to output different voltages.

The connector 13 includes first to twelfth pins 1-12 defined in two rows. The first to eighth pins of the connector 13 are idle. The eleventh pin 11 of the connector 13 is coupled to the power terminal 5V_SB. The twelfth pin 12 of the connector 13 is connected to ground through the resistor R1. The ninth pin 9 of the connector 13 is coupled to the power terminal 12V. The tenth pin 10 of the connector 13 is connected to ground through the resistor R2.

The jumper 30 can be selectively connected between two pins in the different rows of pins of connector 13.

When the power supply unit 20 needs to discharge, such as a discharge operation on the power terminal 5V_SB, the jumper 30 is connected between the eleventh pin 11 and the twelfth pin 12 of the connector 13, or is connected between the eleventh pin 11 and the tenth pin 10. Accordingly, the power of the power supply unit 20 can be discharged through the resistors R1 or R2.

Alternatively, when a discharge operation is made on the power terminal 12V of the power supply unit 20, the jumper 30 is connected between the ninth pin 9 and the twelfth pin 12 of the connector 13, or connected between the ninth pin 11 and the tenth pin 10. Accordingly, the power of the power supply unit 20 can be discharged through the resistors R1 or R2.

In other embodiments, the connector 13 may only include the eleventh and twelfth pins 11 and 12, the jumper 30 is connected between the eleventh pin 11 and the twelfth pin 12 of the connector 13, so as to make the power terminal 5V_SB to discharge more efficiently.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A discharge circuit, comprising:
a power supply unit comprising a first power terminal;
a jumper; and
a connector comprising first and second pins;
wherein the first pin of the connector is coupled to the first power terminal of the power supply unit, the second pin of the connector is connected to ground; the jumper is operable of being connected between the first pin and the second pin, to make the first power terminal to discharge.

2. The discharge circuit of claim 1, wherein the second pin of the connector is connected to ground through a first resistor.

3. The discharge circuit of claim 1, wherein the power supply unit further comprises a second power terminal, the connector further comprises a third pin and a fourth pin; the third pin of the connector is coupled to the second power terminal, the fourth pin is connected to ground; the jumper is operable of being connected between the third pin and the fourth pin.

4. The discharge circuit of claim 3, wherein the fourth pin of the connector is connected to ground through a second resistor.
